(19) United States
(12) Patent Application Publication
(10) Pub. No.: US 2018/0293562 A1
(43) Pub. Date: Oct. 11, 2018

(54) SYSTEMS AND METHODS FOR TRANSACTION PROCESSING

(71) Applicant: CARDFREE, INC., San Francisco, CA (US)

(72) Inventors: Jon Squire, Sausalito, CA (US); Diane Hong, San Anselmo, CA (US); Darren Beyer, San Francisco, CA (US)

(21) Appl. No.: 16/006,480

(22) Filed: Jun. 12, 2018

Related U.S. Application Data
(63) Continuation-in-part of application No. 14/103,848, filed on Dec. 12, 2013, now Pat. No. 10,002,366.
(60) Provisional application No. 61/847,077, filed on Jul. 16, 2013.

(51) Int. Cl. G06Q 20/10; G06Q 20/32; G06Q 20/38; G06Q 20/20; G06Q 30/02; H04L 29/08

(52) U.S. Cl. CPC G06Q 20/102; G06Q 20/3276; H04L 67/26; G06Q 20/204; G06Q 30/0238; G06Q 20/385

(57) ABSTRACT

Pay@Table is the fastest way to pay at restaurants, allowing guests to view and pay for their bill whenever is convenient for them. Pay@Table, as discussed, can be available through a mobile app or without downloading an app such as via a browser interface. Guests can simply use their mobile phones to scan a QR code on their table or bill to quickly be able to view their bill, pay, and close their bill. Payments are processed in seconds and allow guests to use their already set up electronic payment accounts, or quickly scan their credit card to make a payment. Payments are passed directly to the restaurant's point of sale and the table closed, so no extra input is required from wait staff.

### CROSS-REFERENCE TO RELATED APPLICATIONS

This application is a Continuation-in-Part of U.S. patent application Ser. No. 14/103,848, filed Dec. 12, 2013, now U.S. Pat. No. 10,002,366, which claims priority to U.S. Provisional Application No. 61/847,077 filed Jul. 16, 2013, each of which are incorporated herein by reference in their entirety.

### BACKGROUND

The present subject matter relates generally to systems and methods of processing transaction payments. More specifically, the present subject matter provides systems and methods in which transactions are processed for payment from any of a plurality of applicable purses associated with an account, wherein the plurality of purses include values defined by: currency; SKUs; discounts; conditional values; loyalty points; or other non-standard currencies and/or various combinations thereof.

For marketing and other purposes, merchants often provide offers or rewards to their customers. In some instances, the merchant may provide offers or rewards based on units of goods or services (e.g., a free milkshake). Such offers or rewards may be conditional or unconditional. In an example of a conditional offer or reward, prior to earning the reward, the customer may need to meet some predetermined criteria (e.g., receive a free milkshake on a purchase of $10 dollars or more).

The reward can be measured in something other than units of goods or services. In other examples, the rewards may be based on an unconditional value (e.g., an unconditional $10 credit), an unconditional discount (e.g., an unconditional 10% discount), a conditional value (e.g., a $10 credit is provided after specified conditions are met), a conditional discount (e.g., a 10% discount is provided after specified conditions are met), etc.

As a result of these varied offers and rewards, a single transaction may include a combination of values to process. For example, a transaction at a fast food restaurant may include a hamburger, a milkshake, and fries. Each of the goods has an independent price associated with it, which combine to create a total transaction price. But when a reward is provided such that the milkshake is free, the merchant needs to manage a transaction in which a unit of goods (e.g., a milkshake) needs to be credited against a total cash value. We refer to such transactions as non-standard currency transactions.

Currently, merchant offers and rewards that result in non-standard currency transactions are redeemed either manually, such as by entering paper certificates, or performed directly with the Point of Sale (POS) system of the merchant, for example crediting a line item in a transaction. The former is a poor consumer experience and is resource intensive. The latter requires significant interaction at the POS resulting in an inefficient process.

In addition, the payment of such non-standard currency transactions is complicated by the lack of non-standard currency transaction mechanisms. For example, conventional transaction cards, such as loyalty cards, gift cards, and other payment cards, are based on a monetary currency, such as the U.S. dollar. However, having only one value type for payment cards is limiting and does not allow a merchant to provide the creative incentives and marketing tools described herein.

Accordingly, there is a need for systems and methods of transacting that provide merchants and consumers with transactional cards including a plurality of value types, as described and claimed herein.

### BRIEF SUMMARY

The present disclosure provides systems and methods for transaction processing using a plurality of value types. Various examples of the systems and methods are provided herein.

The systems and method provided herein enable more efficient non-standard currency transactions and further enable non-standard currency transaction payment methods, for example by providing accounts including currency and non-currency purses. As a result, using the systems and methods described herein transactions can be processed more efficiently by applying credits to transactions from cash purses and non-cash purses (e.g., a product code purse). The systems and methods provided can be applied to create a more efficient transaction process for instances in which a customer purchases a set of goods while paying for some of the goods in cash and paying for some of the goods with product credits.

In a specific, but non-limiting example, a customer may have a transaction card linked to a transaction account in which there is a cash purse and a non-cash purse. The non-cash purse may be a product code purse where value is measured in units of a given product. To make the example simple, the product code purse may be a milkshake purse with three units of credit. Thus, if the customer were to make a purchase including two hamburgers, two milkshakes, and fries, and made payment using the transaction card, the transaction processing system and method may debit two units of milkshakes from the milkshake purse and then debit the cash value associated with the two hamburgers and fries from the cash purse. This processing of this transaction may occur in a processor in communication with the merchant POS system such that the customer experiences no greater delay or other inefficiency than the customer would paying with any standard (e.g., cash purse only) transaction card.

Numerous examples of the systems and methods described herein may be utilized to accomplish the advantages described. In a first example, the systems and methods disclosed herein involve a customer presenting a unique identifier, possibly in the form of a transaction card, to a merchant POS system, which communicates with a processing engine and associated database, which in turn may communicate with a mobile device. The elements of the disclosed technology cooperate to enable a purchase process in which a transaction may be paid for using value debited against one or more of a combination of transactional values (i.e., transactional credit). While this primary example is relied upon herein for much of the description of the features and functions of the systems and methods provided, the advantages and objects of disclosed technology may be embodied in varied systems and methods that incorporate one or more of the unique elements presented, as will be understood by those skilled in the art based on the descriptions provided herein. For example, the use of varied purse types is a concept that can be employed independently of whether the system or method incorporates a mobile device. Similarly, while described with reference to a merchant POS system, it is known that the systems and methods herein may be used in association with vending machines and other payment processing devices not commonly considered “a merchant POS system.”

In one embodiment, the system of payment for a transaction includes a processing engine configured to receive (a) transaction data including a transaction price and (b) a unique identifier from a merchant POS. The system further includes a database in communication with the processing engine, wherein the database includes a plurality of unique identifiers. Each unique identifier is associated with a cash purse and at least one product code purse, wherein the cash purse and each product code purse have an associated value. The cash purse value is measured in a currency value and the product code purse value is measured in a number of units of an associated product code. In an example, the product code is an SKU, UPC, another unique identifier, or combinations thereof.

The processing engine separates the transaction data into one or more product code values, wherein each product code value being associated with a product code and a corresponding subtotal of the transaction price.

When the processing engine determines a match between the product code associated with one of the product code purses and one of the product codes in the transaction data, the processing engine debits the associated product code value (either transmitted in the transaction data or retrieved from a defined value) from the corresponding product code purse and debits the corresponding subtotal of the transaction price from the transaction price. In one embodiment a maximum value of a product code value may be set in the database. If the value of a matching product code exceeds this maximum value then the maximum value is substituted. After every corresponding subtotal of the transaction price has been debited from the transaction price for matching product codes, the processing engine debits the remaining transaction price from the cash purse value.

In an example, the processing engine is configured to communicate the values associated with the cash purse and product code purse to a mobile device associated with the unique identifier.

If the unique identifier is associated with a purse type including a non-standard value debit purse, a conditional value purse, a conditional discount purse, a conditional SKU purse, a conditional loyalty value purse, and combinations there of, the processing engine is configured to separate the transaction data into values corresponding to the purse type, wherein the processing engine is configured to debit the value corresponding to the purse type from the appropriate purse type.

The disclosure also provides a method of payment including receiving a unique identifier and transaction data including a transaction price and one or more product codes, each with an associated price and applicable sales tax. The method further includes accessing a database including a plurality of unique identifiers, wherein each unique identifier is associated with at least one cash purse and at least one product code purse, wherein each cash purse and product code purse has an associated value, further wherein, the product code purse has an associated product code value. The method includes separating the transaction data into a cash value and a product code value, wherein the cash value is equivalent to the transaction price minus a price associated with the product code value. In an example, the value associated with the product code purse correlates to a number of products.

If the processing engine determines the product code associated with the product code purse matches one of the product codes of the transaction data, then debiting the product code value from the product code purse associated with the unique identifier. If the processing engine determines the value associated with the cash purse is equal to or greater than a cash value of the transaction data, debiting the cash value from the cash purse associated with the unique identifier. The method further includes communicating confirmation of the transaction to a merchant POS system. The method further has the ability to include or exclude any applicable sales tax in the product value.

In another embodiment, the processing engine is configured to communicate the values associated with the cash purse and product code purse to a mobile device associated with the unique identifier.

In another example, the unique identifier may be associated with a non-standard value debit purse, a conditional value purse, a conditional discount purse, a conditional SKU purse, a conditional loyalty value purse, and combinations thereof, and the method includes separating the transaction data into values corresponding to the purse type. The method further includes debiting the value corresponding to the purse type from the appropriate purse type.

In one example, if the unique identifier is not associated with at least one cash purse or product code purse in the database, then the method includes communicating a failure notice to the merchant POS system. Alternatively, or in addition to, if the transaction data includes a transaction cost that is greater than the sum of the values associated with the cash purse and the product code purse in the database, the method includes communicating a failure notice to the merchant POS system. In a further example, if the unique identifier is associated with a discount purse, and if the transaction data satisfies a reward criteria, the method includes debiting a value associated with the discount purse against the transaction price, and then debiting the transaction price from the cash purse.

The present disclosure also provides a payment transaction system comprising a controller and a memory coupled to the controller, wherein the memory is configured to store program instructions executable by the controller. In response to executing the program instructions, the controller is configured to receive transaction data from a merchant POS including a transaction price, at least one product code, a product code value associated with each product code, a number of units associated with each product code, and a unique identifier. The controller is also configured to generate at least two subtotals from the transaction price, wherein a first subtotal includes a first apportioned price and a second subtotal includes a second apportioned price, wherein the second apportioned price is associated with one of the at least one product code, and the number of units associated with the at least one product code. The controller is further configured to, as payment for the first apportioned price, debit the first apportioned price against a cash purse. The controller is configured to, as payment for the second apportioned price, debit the number of units associated with the second apportioned price from a total number of units in a product code purse associated with the unique identifier. The controller is also configured to communicate payment confirmation of the transaction price to the POS.

An advantage of the present systems and methods is processing of non-standard financial transactions through standard ISO 8583 mechanisms.

A further advantage of the systems and methods is processing of non-standard financial transactions through API mechanisms.

Another advantage of the systems and methods is facilitating transaction completion as a single purchase on a POS system with multiple purse types.

Another advantage of the systems and methods is processing discounts and product rewards on a host system instead of the POS.

Yet another advantage of the systems and methods is processing one or more host-based coupons or offers from one or more purses as a part of a payment transaction.

Yet another advantage of the systems and methods is processing virtual currencies at physical POS systems.

Yet another advantage of the systems and methods is the ability to process all non-standard (e.g. non-ISO currency) transactions on a host system with minimal POS impact through either existing ISO payment pathways or through an API.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic illustration of elements of the systems and methods provided herein.

FIG. 2 is a chart illustrating examples of various purse types.

FIG. 3 is a schematic representation of the relationship between a person, a set of transaction cards, and a set of purses.

FIG. 4 is a flow chart illustrating a purchase process in which a transaction is paid for using value debited against a combination of purse types.

FIG. 5 is a transactional flow chart illustrating decision logic in processing a transaction.

FIG. 6 is a flow chart illustrating a sub-flow for SKU rewards.

FIG. 7 is a flow chart illustrating a sub-flow for discounts.

FIG. 8 is a flow chart illustrating a sub-flow for conditional value.

FIG. 9 is a schematic representation of an embodiment of the system.

FIG. 10 is a flow chart illustrating a purchase process in which a transaction is paid for using value debited against a combination of purse types.

FIG. 11 illustrates exemplary scannable codes usable with aspects of the technology.

FIG. 12 illustrates an exemplary architecture and operation flow of an embodiment of the disclosed technology.

FIG. 13 illustrates another exemplary architecture and operation flow of an embodiment of the disclosed technology.

### DETAILED DESCRIPTION

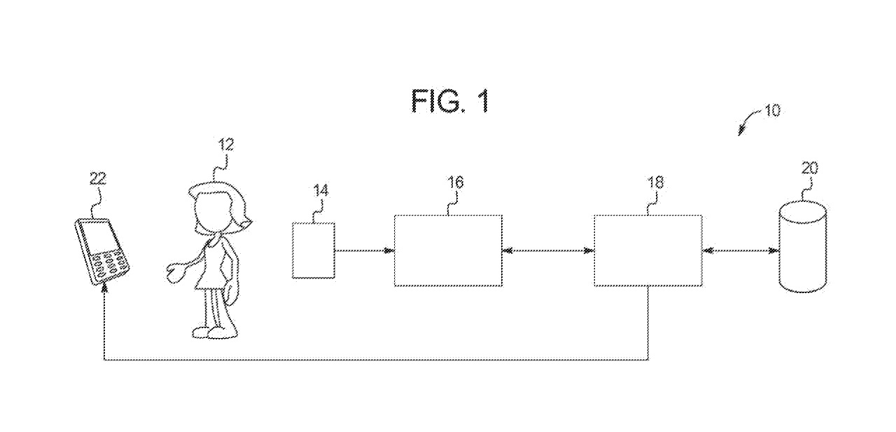

The systems and methods 10 disclosed herein are described by way of the following examples. In these examples, the various features and functions of the systems and methods 10 are described with reference to a customer 12, a transaction payment account and associated access device 14 (e.g., transaction card 14), a merchant POS system 16, a processing engine 18, a database 20, and a mobile device 22. These elements are shown in FIG. 1, wherein a customer 12 presents a unique identifier 13, in certain examples by way of a transaction card 14 to a merchant POS system 16, which communicates with a processing engine 18 and associated database 20, as described further herein, which in turn may communicate with a mobile device 22.

While shown as separate elements in FIG. 1, the transaction card 14 and the mobile device 22 may be embodied in a single element, for example, a communication enabled transaction card 14 or a mobile device 22 including transaction card data, such as the unique identifier 13. While the merchant POS system 16 is may be understood in the context of the examples provided herein to describe the current versions of known merchant POS systems 16, it is understood that the teachings provided herein are applicable to future versions of or alternatives to the current merchant POS system 16. Further, the merchant POS system 16 includes, but is not limited to alternative payment processing devices including, cashier systems, online payment systems, and vending machine systems, among others. Similarly, while the mobile devices 22 may presently be understood to encompass various smartphones, tablets, wearable computing devices, and the like, the teachings provided herein are applicable to any present or future mobile computing device.

The elements shown in FIG. 1 cooperate to enable a purchase process in which a transaction may be paid for using value debited against one or more of a combination of purse types 24. As used herein, purse types 24 are categories by which transactional value (i.e., transactional credit) is defined.

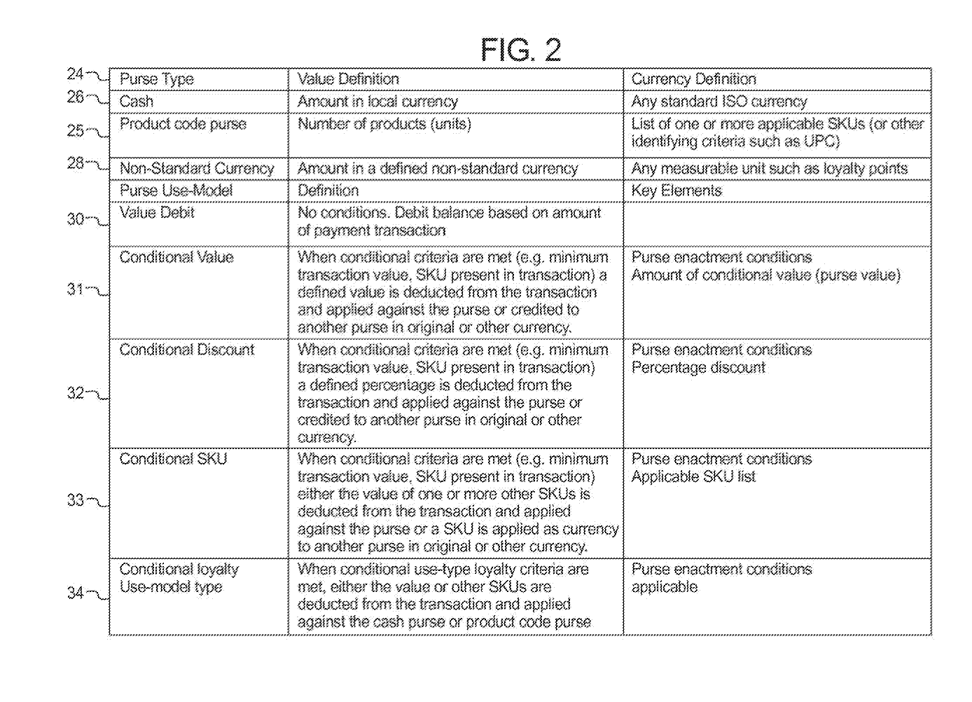

FIG. 2 is a chart illustrating three different purse types 24 that are used in the examples of the systems and methods 10 provided herein. Additionally four purse use-models 25 are illustrated in FIG. 2. The purse types 24 are the measurement units that store value in the account. The use-models 25 describe how the value of the purse may be redeemed. It is understood that those skilled in the art will recognize other purse types 24 and use-models 25 that may be substituted for, or used in addition to, the purse types 24 and use-models 25 shown in FIG. 2. However, for clarity of the description, the purse types 24 in the examples described herein have been limited to the three purse types 24 and four use-models 25 shown in FIG. 2.

In one embodiment, the system 10 of payment for a transaction includes a processing engine 18 configured to receive (a) transaction data 19 including a transaction price 21, and (b) a unique identifier 13 from a merchant POS system 16. The system 10 further includes a database 20 in communication with the processing engine 18, wherein the database 20 includes a plurality of unique identifiers 13. Each unique identifier 13 is associated with a cash purse 26 and at least one product code purse 27, wherein the cash purse 26 and each product code purse 27 have an associated value. The cash purse value 29 is measured in a currency value and the product code purse value 45 is measured in a number of units of an associated product code. In an example, the product code is any identifying code, such as an SKU, UPC, or combinations thereof. It is understood that while many embodiments may include a cash purse 26 associated with the unique identifier 13, not all uses of the systems and methods provided herein rely on use of a cash purse 26. For example, a unique identifier 13 may be associated with one or more product code purses 26 and/or one or more non-standard currency purses 28 without being associated with a cash purse 26. Those skilled in the art will understand such embodiments based on the examples provided herein.

FIG. 1 will be expanded to include the transaction data elements that are communicated from the POS to the processing engine and back from this part of the description.] Upon receipt of transaction data 19, the processing engine 18 separates the transaction data 19 into one or more product code values 46, wherein each product code value 46 is associated with a product code 47 and a corresponding subtotal 49 of the transaction price 21. For example, the processing engine 18 may recognize from the transaction data 19 that the product code value 46 is associated with a product code 47 associated with milkshakes having a certain subtotal 49 associated with the cost of the milkshake that the processing engine 18 subtracts from the transaction price 21.

When the processing engine 18 determines a match between the product code 47 associated with one of the product code purses 27 and one of the product codes 47 in the transaction data 19, the processing engine 18 debits the associated product code value 46 from the corresponding product code purse value 45 and debits the corresponding subtotal 49 of the transaction price 21 from the transaction price 21. After every corresponding subtotal 49 of the transaction price 21 has been debited from the transaction price 21 for matching product codes 47, the processing engine 18 debits the remaining transaction price 21 from the cash purse value 29.

In an example, the processing engine 18 is configured to communicate the values associated with the cash purse 26 and product code purse 27 to a mobile device 22 associated with the unique identifier 13 such that a user is able to monitor receipts and/or account status through the mobile device 22. For example, the processing engine 18 may provide the cash purse value 29 in terms of currency to a user interface 90 of the mobile device 22. Similarly, the processing engine 18 may provide the product code purse value 45 in terms of the number of units of a product to a user interface 90 of the mobile device 22.

As shown, if the unique identifier 13 is associated with a purse type 24 including a product code purse 27 and/or a non-standard value purse 28 (which may use any of; a value debit use-model 30, a conditional value use-model type 31, a conditional discount use-model type 32, a conditional SKU use-model type 33, a conditional loyalty value use-model type 34), the processing engine 18 is configured to separate the transaction data 19 into values corresponding to the purse type 24, wherein the processing engine 18 is configured to debit the value corresponding to the purse type 24 from the appropriate purse type 24.

The disclosure also provides a method of payment including receiving a unique identifier 13 and transaction data 19 including a transaction price 21 and one or more product codes 47. The method further includes accessing a database 20 including a plurality of unique identifiers 13, wherein each unique identifier 13 is associated with at least one cash purse 26 and at least one product code purse 27, wherein each cash purse 26 and product code purse 27 has an associated value, further wherein, the product code purse 27 has an associated product code 47. The method 10 includes separating a the transaction data 19 into a cash value 51 and a product code value 46, wherein the cash value 51 is equivalent to the transaction price 21 minus a price associated with the product code value 46. In an example, the value associated with the product code purse 27 correlates to a number of products.

If the processing engine 18 determines the product code 47 associated with the product code purse 27 matches one of the product codes 47 of the transaction data 19, then the processing engine 18 debits the product code value 46 from the product code purse 27 associated with the unique identifier 13. If the processing engine 18 determines the value associated with the cash purse 26 is equal to or greater than a cash purse value 29 of the transaction data 19, then the processing engine 18 debits the cash purse value 29 from the cash purse 26 associated with the unique identifier 13. The method further includes communicating confirmation of the transaction to a merchant POS system 16.

In another embodiment, the processing engine 18 is configured to communicate the values associated with the cash purse 26 and product code purse 27 to a mobile device 22 associated with the unique identifier 13.

In another example, the unique identifier 13 is associated with a purse type 24 including a product code purse 27 and/or a non-standard value purse 28 (which may use any of; a value debit use-model 30, a conditional value use-model type 31, a conditional discount use-model type 32, a conditional SKU use-model type 33, a conditional loyalty value use-model type 34), and the method 10 includes separating the transaction data 19 into values corresponding to the purse type 24. The method 10 further includes debiting the value corresponding to the purse type 24 from the appropriate purse type 24.

In one example, if the values associated with the one or more purse types 24 are not sufficient to cover the transaction price 21, then the method 10 includes communicating a failure notice to the merchant POS system 16. Alternatively, or in addition to, if the values associated with the one or more purse types 24 are not sufficient to cover the transaction price 21, then the method 10 includes communicating instructions for the customer associated with the unique identifier 13 for providing additional payment funds or sources. Accordingly, the transaction may still be completed by using a different payment method.

In another example, if the transaction data 19 includes a transaction price 21 that is greater than the sum of the values associated with the cash purse 26 and the product code purse 27 in the database 20, the method 10 includes communicating a failure notice to the merchant POS system 16.

In a further example, if the unique identifier 13 is associated with a purse type 24 having a conditional discount use-model type 32, and if the transaction data 19 satisfies the conditional discount use-model type 32 criteria, the method includes debiting a value associated with the purse type 24 against the transaction price 21.

As shown in FIG. 2, the purse types 24 in this example include, but are not limited to: a cash purse 26; a product code purse 27, such as an SKU purse type 27; and a non-standard value purse type 28. Each of purse type 24 may have a use-model 25 including, but not limited to: a standard value debit model type 30; a conditional value use-model type 31; a conditional discount use-model type 32; a conditional SKU use-model type 33; and a conditional loyalty value use-model type 34. Each of the purse types 24 and use-models 25 is described in further detail below.

In the cash purse 26, the cash purse value 29 is defined as a currency value, typically a local currency (e.g., U.S. dollars). The cash purse value 29 is easy to understand as the equivalent cash value of the currency used.

With respect to the product code purse 27, the product code purse value 45 is defined in units of the relevant product code 47. For example, in a given merchant POS system 16, there may be one or more specific SKUs associated with a milk shake. The product code purse 27 may, for example, store a value of three milk shakes of any flavor. While described herein as SKUs, the product code purse type 27 may alternatively utilize UPCs or any other identifying product codes. The concept being that the value of the product code purse type 27 is directly correlated to a number of products, and the currency of the purse type is defined as a list of applicable SKUs, UPCs or other identifying criteria. A local currency value may be assigned to each purse SKU for the purposes valuing the totality of the SKU purse in the local currency.

In the non-standard currency purse 28, value may be defined as points or other unit of measure (e.g., loyalty points). The value of the non-standard currency purse 28 is the amount of non-standard currency present. The currency is any defined unit of measure (e.g. loyalty points, stars, etc.). In addition, non-standard currency purses 28 may be provided based on virtual currencies, such as, for example, Facebook Credits.

In the value debit use-model type 30, value is accessed as an unconditional debit.

In the conditional value use-model type 31, value is accessed subject to a conditional test. For example, there may be a spending threshold that must be exceeded before the purse value is applied, a date within which the transaction must occur in order for the purse value to be applied, a minimum number of items to purchase in order for the purse value to be applied, etc.

Similar to the conditional value use-model type 32, in the conditional discount purse type 32, a discount is applied subject to a conditional test. For example, if a customer 12 spends $10, the conditional discount use-model type 32 may have a discount value of 20% and be enacted to deduct $2 (20%) from the transaction amount and apply it against the transaction price 21.

Similar to the conditional value use-model type 32, in the conditional SKU use-model type 33, value is accessed subject to a conditional test. In one example, if a minimum transaction value is met (e.g., the customer 12 spends $10), the conditional SKU use-model type 33 removes the price of the milkshake from the current transaction. In another example, the conditional test may be based on the presence of a given SKU in the transaction data 19. For example, if the SKU for a milkshake is included in the transaction data 19, the conditional test is met and the value is applied. In a more complicated example, the conditional test may require the presence of multiple product codes associated with multiple products to be identified in the transaction data 19 (e.g., the value is provided if the transaction data 19 includes at least the product codes for two milkshakes as well as one order of fries). The value may be a monetary value discount, a percentage discount, an SKU credit, etc. As shown, the conditional SKU use-model type 33 examples include conditional tests and/or values that relate to product codes.

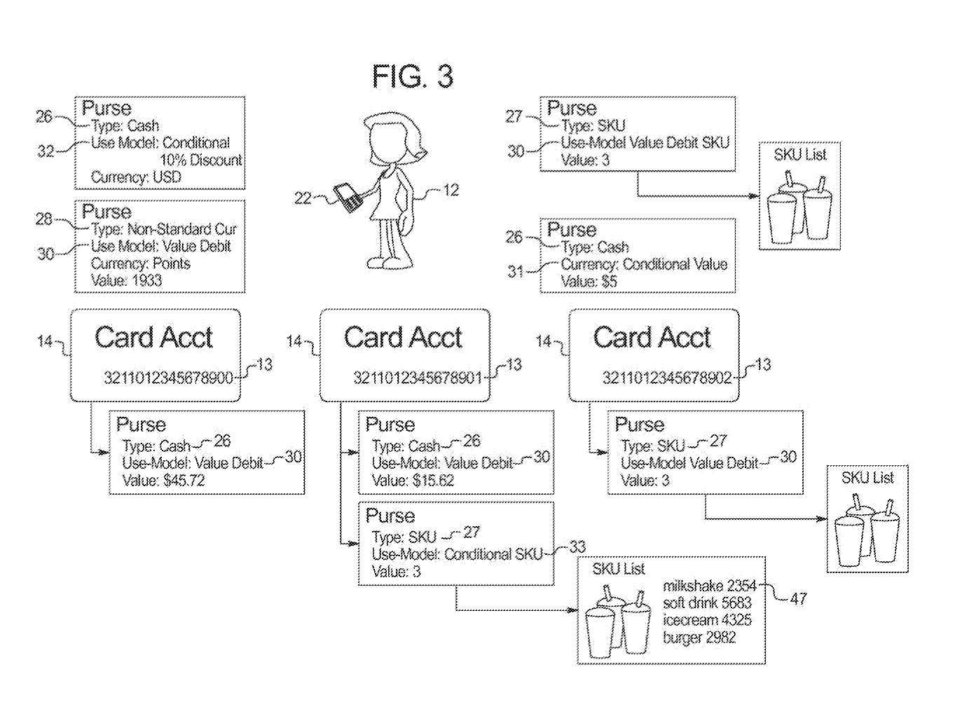

The explanation of the purse types 24 and use-models 25 shown in FIG. 2 continues in further detail with reference to FIGS. 3-8.

Turning now to FIG. 3, the relationship between a customer 12, a set of transaction cards 14, and a set of purse types 24 is shown. As shown, a customer 12 may present an associated unique identifier 13 to a merchant POS, wherein the unique identifier 13 may be associated with a number of purse types 24 having associated values. The unique identifier 13 may be, but are not necessarily, associated with one or more transaction cards 14. As shown in FIG. 3, the customer 12 may have three separate transaction cards 14, each having a unique identifier 13 corresponding to a set of purse types 24.

For example, the unique identifier 13 may be associated with a cash purse 26 with a conditional discount use-model 32 (e.g., a 10% discount with currency USD), an SKU purse type 27 with a value debit use-model 30 (e.g., a reward valued as three milk shakes), a cash purse 26 with a conditional value use-model 31 (e.g., a conditional value with a value of $5 USD), and a non-standard currency purse type 28 with a value debit use-model 30 (e.g., a loyalty points purse with a value of 1933). These purse types 24 may be associated with the customer 12 in numerous ways, including a customer account accessible by: a login and password; an account number; other identification; or through a mobile app resident on the mobile device 22.

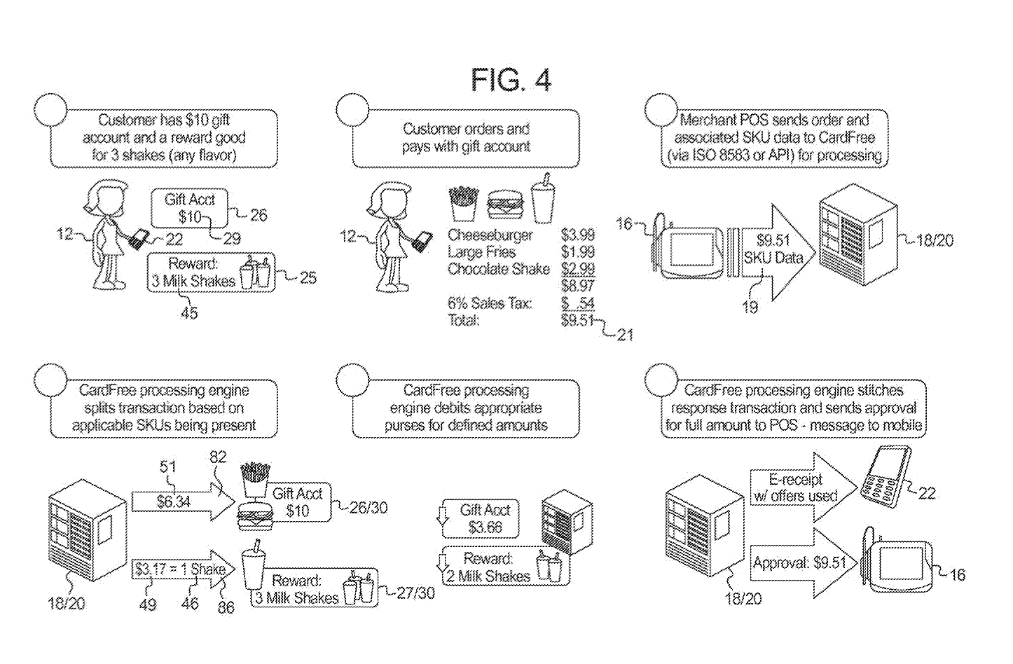

Additionally, as shown, the customer 12 may be associated with one or more transaction cards 14 each of which may be associated with one or more purse types 24 and associated values. For example, a first transaction card 14 may be associated with a cash purse 26 with a value debit use-model type 30 (e.g., a $45.72 USD value), a second transaction card 14 may be associated with a cash purse 26 with a value debit use-model type 30 (e.g., a $15.62 USD value) and an SKU purse type 27 with a conditional SKU use-model type 33 (e.g., a reward valued as three milk shakes which may be utilized if specified conditions are met), and a third transaction card 14 may be associated with an SKU purse type 27 with a value debit use-model type 30 (e.g., a card 14 valued as three milk shakes). The redemption of the value associated with the purse types 24 is now described with reference to FIGS. 4-8.

FIG. 4 illustrates a purchase process in which a transaction is paid for using value debited against a combination of purse types 24. The purse types 24 used in the example shown in FIG. 4 are a cash purse 26 and an SKU purse type 27, though it is understood that the example provided is instructive in how any purse type 24 and any combination of purse types 24 may be used.

As shown in FIG. 4, a customer 12 may use her mobile device 22 (and an associated mobile app resident on the mobile device 22) to provide an identifying criteria to access values associated with a cash purse 26 with value debit use-model type 30 and an SKU purse type 27 with a value debit use-model type 30. In this example, the cash purse 26 has a value of $10 and the SKU purse type 27 has a value of three milk shakes. The customer 12 purchases a cheeseburger ($3.99), large fries ($1.99), and a chocolate shake ($2.99). The sub-total of the purchase is $8.79, at a rate of 6% the tax is $0.54, and the total is $9.51.

The customer 12 pays for the transaction using the values associated with the cash purse 26 and the SKU purse type 27 that are each associated with the customer 12 in the host system and communicated via mobile device 22. The mobile device 22 communicates with a POS system 16 that communicates both the total (i.e., $9.51) and the SKU and related data (i.e., cheeseburger/SKU/pricing, large fries/SKU/pricing, and a chocolate shake/SKU/pricing) to a processing engine 18 and associated database 20. The processing engine 18 splits the transaction data into constituent parts based on the purse types 24.

For example, in the example shown in FIG. 4, the transaction is separated into a first subtotal 82 including the cheeseburger and large fries, which is to be paid for using the value associated with the cash purse 26, and into a second subtotal 86 including the milk shake, which is to be paid for using the value associated with the SKU purse type 27. The cost associated with the first subtotal 86 is $6.34, which is the cheeseburger ($3.99) and large fries ($1.99) plus the 6% tax. The cost associated with the second subtotal 86 is $3.17, which is the milk shake ($2.99) plus the 6% tax.

The processing engine 18 then debits the appropriate values from each of the purse types 24, the values being stored in the database 20 associated with the processing engine 18. In this example, the $6.34 is deducted from the $10 value in the cash purse 26 leaving a value of $3.66 and one milk shake is deducted from the SKU purse type 27 leaving a value of two milk shakes. The processing engine 18 then communicates the approval for the full amount to the merchant POS system 16 and communicates the updated values in the purse types 24 via a message to the mobile device 22. It should be noted that while the example of the cash purse 26 described above is a prepaid debit value (e.g., a value stored on a gift card), the cash purse 26 could alternatively be a line of credit.

As shown, the processing engine 18 is the brain of the systems and methods 10 that enables a transaction to be credited against values stored in one or more purse types 24. While shown using a specific example, it is understood that those skilled in the art will understand how the processing engine 18 may be implemented to break a transaction into one or more sub-transactions to be credited against values stored in one or more related purse types 24.

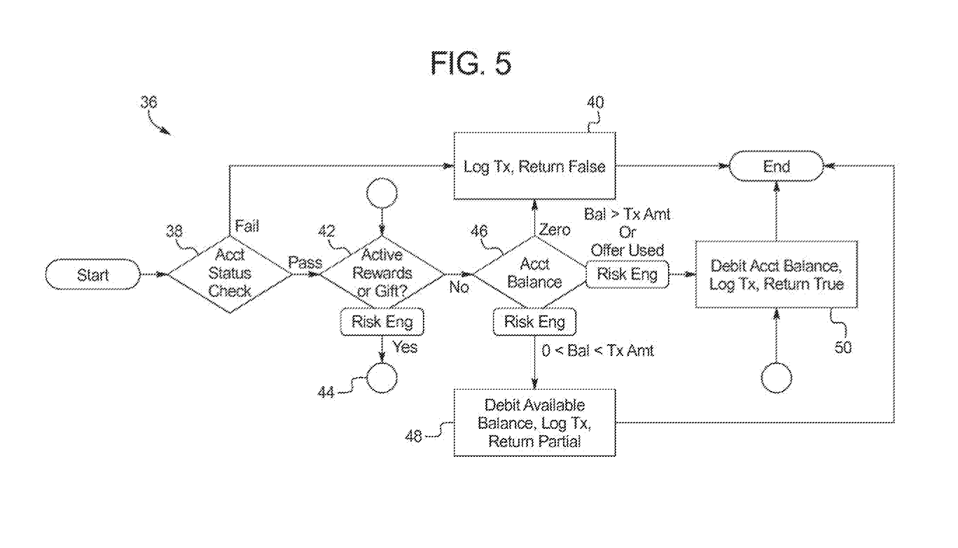

Turning now to FIG. 5, a transaction flow 36 illustrating an example of the operation of the processing engine 18 is shown. As shown in FIG. 5, the processing engine 18 may receive information related to a transaction to process, which starts the transaction flow 36. In a first step 38, the processing engine 18 performs an account status check in which the processing engine 18 identifies whether the information presented to the merchant POS system 16 (or directly to the processing engine 18) is associated with an active account. If the information presented to the merchant POS system 16 (or directly to the processing engine 18) is not associated with an active account, in a second step 40, the processing engine 18 logs the transaction and communicates the failure to the merchant POS system 16. If the information presented to the merchant POS system 16 (or directly to the processing engine 18) is associated with an active account, the transaction flow 36 moves to a third step 42.

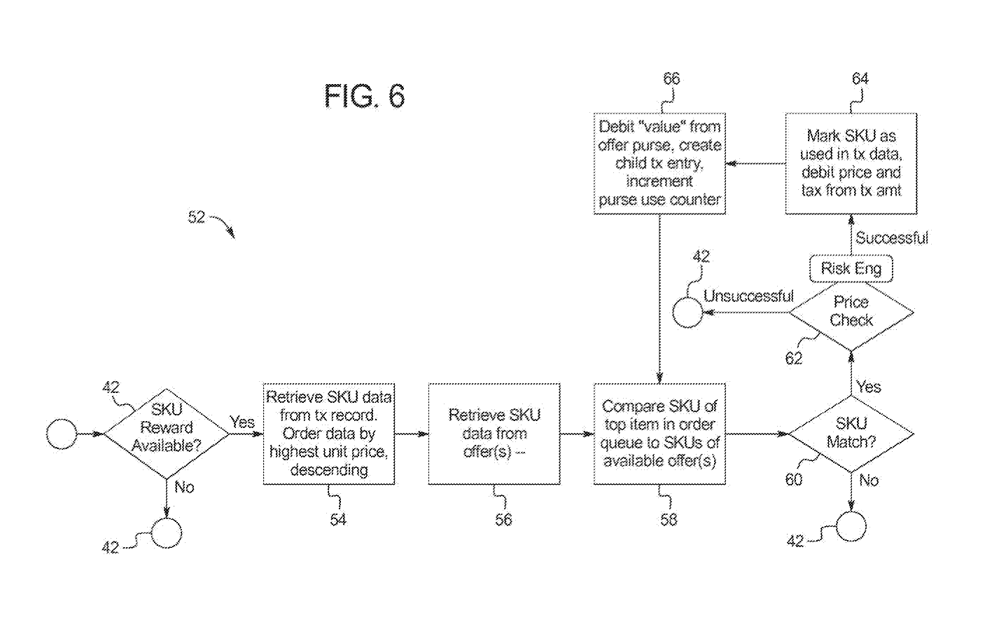

In the third step 42, the processing engine 18 determines whether there are any active values in one or more purse types 24 that may be applied against the transaction. If so, the transaction flow 36 is diverted to one of the sub-flows 44 shown in FIG. 6-8, as described further below. If not, the transaction flow 36 moves to a fourth step 44 in which an account balance is determined and compared against the transaction cost. If there is no account balance, the second step 40 is triggered through which the processing engine 18 logs the transaction and communicates the failure to the merchant POS system 16.

If the account balance is greater than zero, but less than the cost of the transaction, a fifth step 48 is triggered in which the available balance is debited, the transaction is logged, and a partial completion of the transaction is communicated to the merchant POS system 16.

If the account balance is greater than the cost of the transaction, a sixth step 50 is triggered in which the available balance is debited by the cost of the transaction, the transaction is logged, and a full completion of the transaction is communicated to the merchant POS system 16.

FIG. 6 is a sub-flow 44, specifically an SKU reward sub-flow 52. As shown in FIG. 5, in a first sub-step 42a of the third step 42, when the processing engine 18 determines there is an active value in an SKU purse type 28 that may be applied to the transaction, the processing engine 18 initiates the SKU reward sub-flow 52. When initiated, the SKU reward sub-flow 52 proceeds to a first step 54 in which the processing engine 18 retrieves the SKU data from the transaction record. In a preferred embodiment, the data is ordered in a descending order of unit price.

In a second step 56, the processing engine 18 retrieves any SKU data from any active values associated with any associated SKU purse types 28.

In a third step 58, the processing engine 18 compares the SKU of the top item in the sequenced data to the SKU values in the one or more SKU purse types 28.

In a fourth step 60, the processing engine 18 determines whether there is an SKU match. If there is not, the processing engine 18 returns to the third step 42 in the transaction flow 36. If the processing engine 18 determines there is an SKU match, the processing engine 18 runs a price check in a fifth step 62. If the price check is successful, the SKU is marked as used in the transaction data and the price and tax are debited from the transaction data, in a sixth step 64.

Then, in a seventh step 66, the processing engine 18 debits the value of the matched SKU from the value in the appropriate SKU purse type 27, creates a child transaction entry, and increments a use counter in the SKU purse type 27.

If, in the fifth step 62, the price check is not successful, the processing engine 18 returns to the third step 42 in the transaction flow 36.

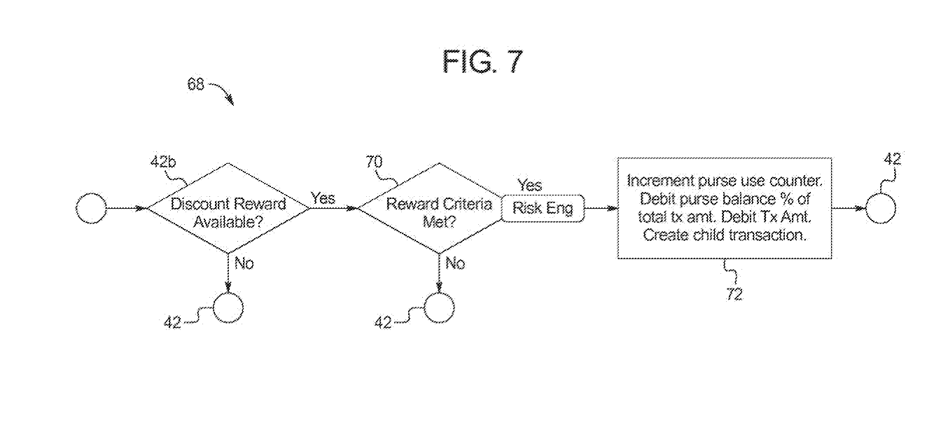

FIG. 7 is a sub-flow 44, specifically a discount sub-flow 68. As shown in FIG. 5, in a first sub-step 42b of the third step 42, when the processing engine 18 determines there is an active value in a discount purse type 30 that may be applied to the transaction, the processing engine 18 initiates the discount sub-flow 68. When initiated, the discount sub-flow 68 proceeds to a first step 70 in which the processing engine 18 determines whether the reward criteria has been met. If not, the processing engine 18 returns to the third step 42 in the transaction flow 36. If so, the processing engine 18 proceeds to a second step 72 in which the processing engine 18 increments the purse use counter, debits the active value in the discount purse type 30 a percentage of the total transaction payment due, applies that credit to the transaction, and creates a child transaction record. The discount sub-flow 68 then returns to the third step 42 in the transaction flow 36.

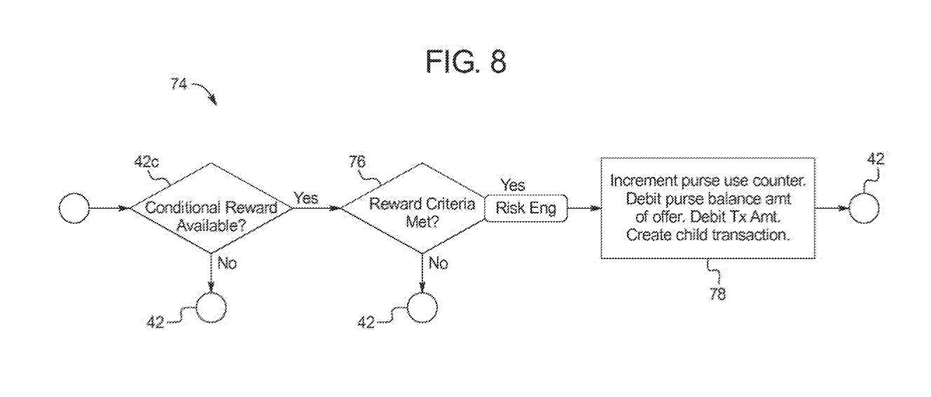

FIG. 8 is a sub-flow 44, specifically a conditional value sub-flow 74. As shown in FIG. 5, in a first sub-step 42c of the third step 42, when the processing engine 18 determines there is an active value in a conditional value use-model type 31 on an active purse and/or a conditional SKU use-model type 33 on an active purse that may be applied to the transaction, the processing engine 18 initiates the conditional value sub-flow 74. When initiated, the conditional value sub-flow 74 proceeds to a first step 76 in which the processing engine 18 determines whether the reward criteria has been met. If not, the processing engine 18 returns to the third step 42 in the transaction flow 36. If so, the processing engine 18 proceeds to a second step 76 in which the processing engine 18 increments the purse use counter, debits the active value in the conditional value use-model type 31 purse type 26-28 and/or a conditional SKU use-model type 33 purse type 26-28 by the amount of the offer, applies that credit to the transaction, and creates a child transaction record. The conditional value sub-flow 74 then returns to the third step 42 in the transaction flow 36.

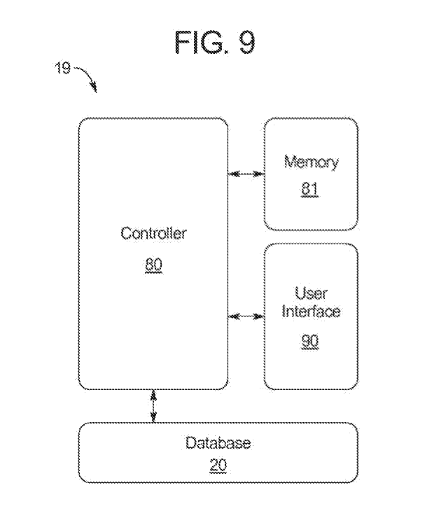

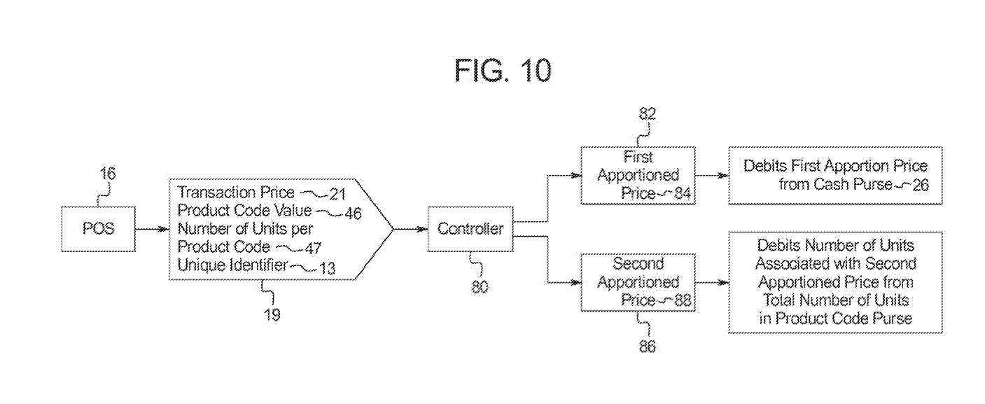

As shown in FIG. 9, the present disclosure provides a processing engine 18 embodied in a controller 80 and a memory 81 coupled to the controller 80, wherein the memory 81 is configured to store program instructions executable by the controller 80. In response to executing the program instructions, the controller 80 is configured to receive transaction data 19 from a merchant POS 16 including a transaction price 21, at least one product code value 46 associated with each product code, a number of units 47 associated with each product code, and a unique identifier 13. In addition, the controller 80 may also receive a sales tax amount per product code from the merchant POS 16 either separately or included within the transaction price 21. As shown in FIG. 10, the controller 80 is configured to generate at least two subtotals from the transaction price 21, wherein a first subtotal 82 includes a first apportioned price 84 and a second subtotal 86 includes a second apportioned price 88, wherein the second apportioned price 88 is associated with one of the at least one product code, and the number of units associated with the at least one product code.

The controller 80 is further configured to, as payment for the first apportioned price 84, debit the first apportioned price 84 against a cash purse 26. The controller 80 is configured to, as payment for the second apportioned price 88, debit the number of units associated with the second apportioned price 88 from a total number of units in a product code purse 27 associated with the unique identifier 13. The controller 80 is also configured to communicate payment confirmation of the transaction price 21 to the POS system 16.

As shown, the controller 80 is in direct communication with the searchable storage structure, which, in one example, may be the database 20. Of course, in other embodiments, the system 10 may be in communication with the database 20 through a network. While shown and described as a database 20, it is understood that the database 20 may be any number of databases adapted to support the necessary data management to support the various features and functions of the system 10 described herein. It is further contemplated that a database 20, as understood in the traditional sense, may not be a requirement of the system 10 described herein, and that any other mechanism or mode of data management may be employed.

In one example, the system 10 includes an electronic device, such as a portable electronic mobile device 22 embodied in a touchscreen-enabled smartphone as the user interface 90. However, it is understood that the teachings provided may be applied to numerous variations of mobile devices 22 with user interfaces 90, including desktop computers, remote controls, etc., as will be recognized by those skilled in the art based on the teachings herein.

An additional aspect relates to a more efficient and secure payment technology. This aspect can optimally be used in conjunction with any one or more of the other embodiments disclosed herein. This aspect at least allows a more efficient, convenient and secure technology to, for example, pay for a good or service.

An exemplary embodiment, that can be referred to as “Pay@Table” (although the technology is not limited to only paying at a table) provides a fast way to pay at restaurants (or in at general any location, store, shop, etc., where a purchase is made), allowing guests to view and pay for their bill whenever is convenient for the guest. One exemplary embodiment provides Pay@Table through a mobile app or, for example, via a web page that may not require the downloading and installing of an app. Guests can simply use their mobile phones to scan a QR code on their table or bill to quickly view, pay, and close their bill. While the exemplary embodiment for Pay@Table will be discussed in relation to a QR code, it is to be appreciated that the technology is not limited thereto any can also be used in general with any scannable code, such as a bar code, with RF (Radio Frequency) tags (RFID), bokodes, interactive barcodes, beacons, or in general any comparable technology.

An exemplary embodiment allows payments to be processed in seconds and allow guests to use their already set up Google®, Apple® Pay®, or comparable account, or quickly scan their credit card to effect the payment. These payments can be passed directly to the restaurant's point of sale and the table closed, so no extra input is required from wait staff. This not only increases wait staff efficiency, but also strengthens security in that fewer people have access to payment information, and also enhances user experience by lessening time for paying for goods/services.

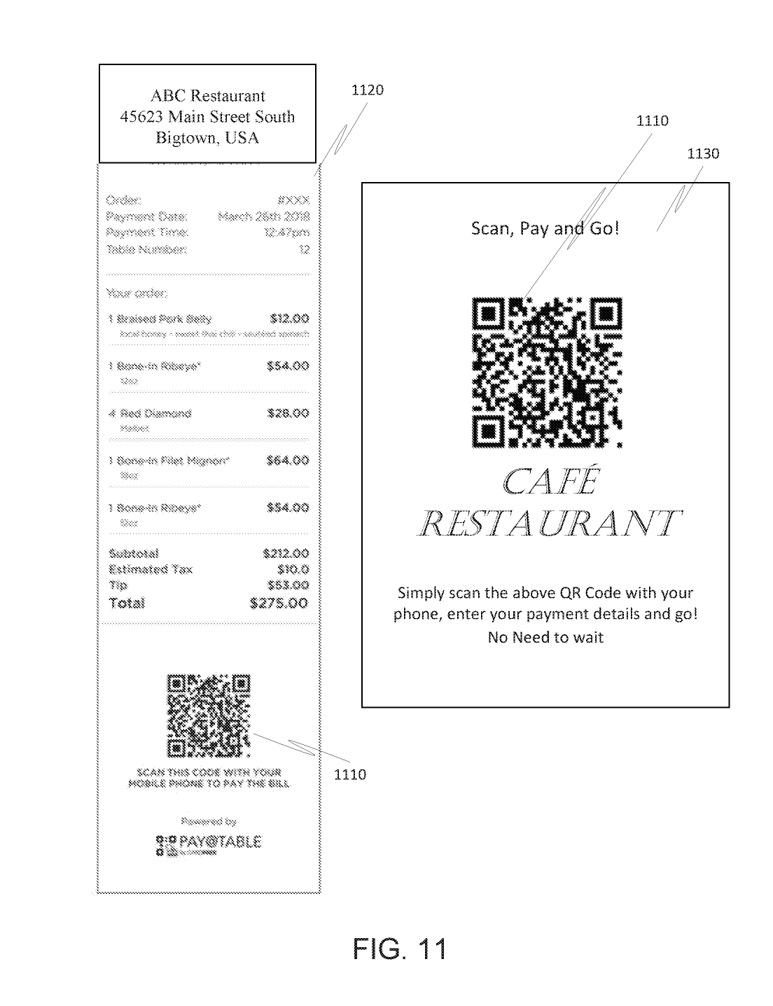

FIG. 11 illustrates exemplary scannable codes 1110 usable with aspects of the disclosed technology. For the following illustrative embodiment, a scenario will be described in relation to a customer paying at a restaurant by scanning a QR code on a bill 1120 or, for example, on a card 1130 on their table, a menu, on the door, or at some other location(s) at the restaurant.

Alternatively, or in addition, an identifier that works in a similar manner to the scannable code 1110 could be communicated to a guest's smartphone with this identifier usable as the QR code to facilitate payment as discussed herein.

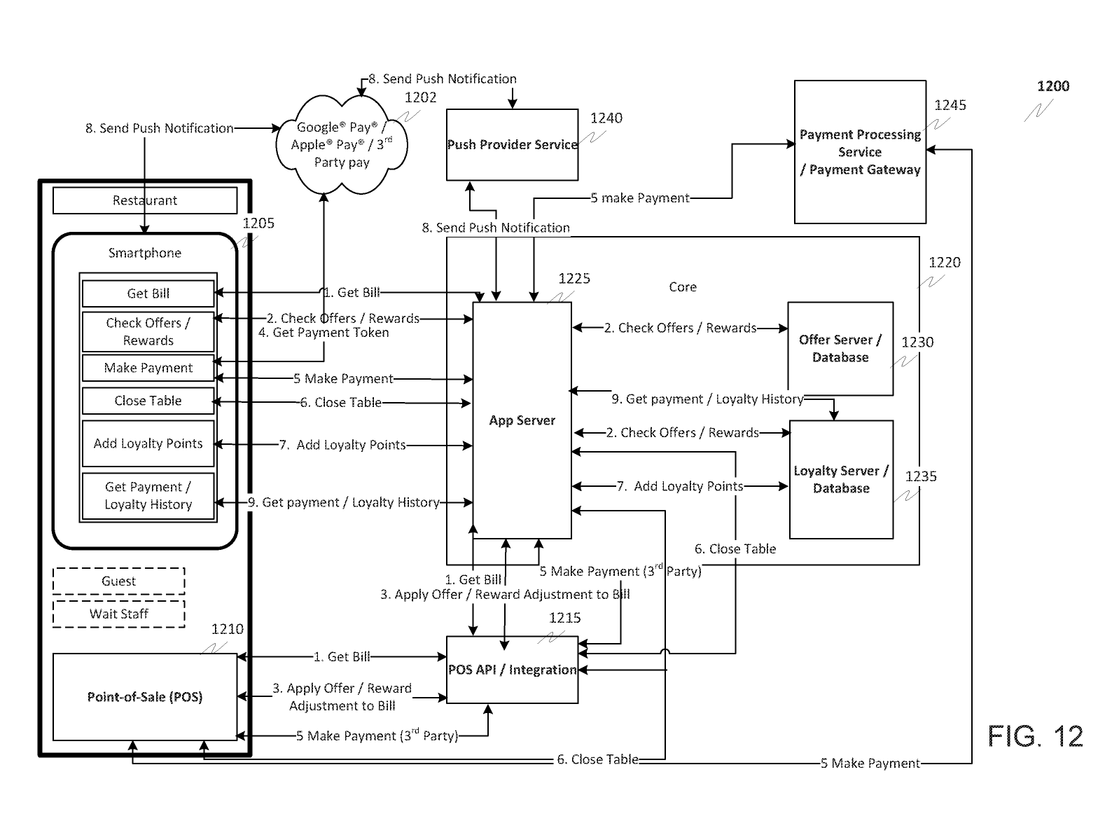

FIG. 12 illustrates an exemplary architecture and operational flow 1200 for a mobile experience of the Pay@Table technology. The exemplary architecture includes a smartphone (or equivalent device) 1205 at the restaurant, a Point-of-Sale (POS) 1210, cloud payment provider(s) 1202, a push provider service 1240, a payment processing service/gateway 1245, a POS API/Integration service 1215, and a core 1220 which includes an app server 1225, an offer server/database 1230 and a loyalty server/database 1235. All of the various elements are connected by one or more links (or secure links) that include any known wired or wireless technology (or combination thereof). Additionally, any one or more of the communications or communications channels/links herein can use secure communication protocols such as https, SSL, TLS, IPSec, encryption, or the like.

In accordance with an exemplary operation, the process begins with acquisition of the bill (Step 1). The user scans the QR code on the bill, table tent, card, etc., using a camera on the smartphone 1205 and associated mobile app. The QR contains the following information:
Merchant ID
Store ID
Table #

This information is then forwarded to the app server 1225 for processing. This information is used and forwarded to the POS API/Integration service 1215 for that particular restaurant location identifier (Merchant ID). The POS API/Integration service 1215 contacts the POS 1210 where the order information for that table is collected. This order information can then be communicated to the smartphone 1205 for display to the guest.

In optional step 2, the app server 1225 queries the offers server/database 1230 to determine whether there are any applicable offer(s) available for the items the guest has selected to purchase in that particular store. If offers are available, the offers server/database 1230 communicates the offer information, such as a discount, to the app server 1225 where the discount will be applied and displayed on the bill which is communicated to the guest. In a similar manner, the loyalty server/database 1235 will check to see if the guest has any available rewards they can redeem. If there are rewards to redeem, the rewards can be handled in a similar manner as any offers in step 3 with the application of any offers/rewards/discounts applied to the bill on the POS 1210 via the POS API/Integration service 1215.

In step 4, the guest selects to pay using an electronic pay service such as Google® Pay® (Android®) or Apple® Pay® (iPhone®) on the mobile app. The selection of use of the electronic payment triggers a payment data request that is sent from the mobile app to the appropriate electronic pay service 1202. The electronic pay service 1202 then forwards a token to the device 1205. This token is then used in the next step for a make payment call.

Step 5 is a make payment step. Once the token has been returned by electronic pay service, the token is forwarded to the core 1220, and in particular the app server 1225, as a payment request. The payment request is then subsequently directed from the app server 1225 to the payment processor 1245 for capture and settlement with the merchant. Once the payment has been successfully processed, the payment information is sent to the POS API/Integration service 1215 and then directed to the POS 1210.

The payment can be logged in the POS 1210 as a 3rd party payment on behalf of the core 1220. The response from the POS 1210 is returned to the device 1205 for the next step in the process. The merchant can see all payments made through their POS 1210, and this logged amount can then be seen as a settlement amount into the payment processor merchant account.

In step 6, and once the response has been received that the payment has been successfully processed, the table and corresponding ticket can then be closed. The request to close is sent to the POS 1210 via the POS API/Integration service 1215. The success of payment response is then sent back to the device 1205.

In optional step 7, loyalty points will be calculated with the cooperation of the app server 1225 and loyalty server/database 1235 based on money spent/frequency of visits and added to the guest's account.

In step 8, and once the payment has been successfully processed and the table order closed, a success confirmation screen can be presented to the guest on the device 1205. At this point a push notification triggered by the app server 1225 can be sent via the push provider service 1240 containing one or more of the following portions of information:
Merchant Information
Time and date information
Amount paid
Breakdown of charges
Payment method used
Payment Confirmation information
Loyalty Points Earned (if applicable)
Rewards earned (if applicable)
A Thank you for the visit
Optional Merchant Advertising/Survey

This information is received by the device 1205 and optionally stored.

In step 9, the guest can review their payment history at any time. The payment history can contain one or more of the following types of information:
Merchant Information
Time and date information
Order number
Table Number
Date and time the order was closed
Wait staff name
Loyalty points earned
Order Items
Discounts (Offers/Rewards)
Tip
Tax
Total
Payment method

For tips and other similar adjustments to the bill, the guest can make these modifications to the bill after receipt of the bill and before making payment by, for example, entering a tip amount on the device 1205.

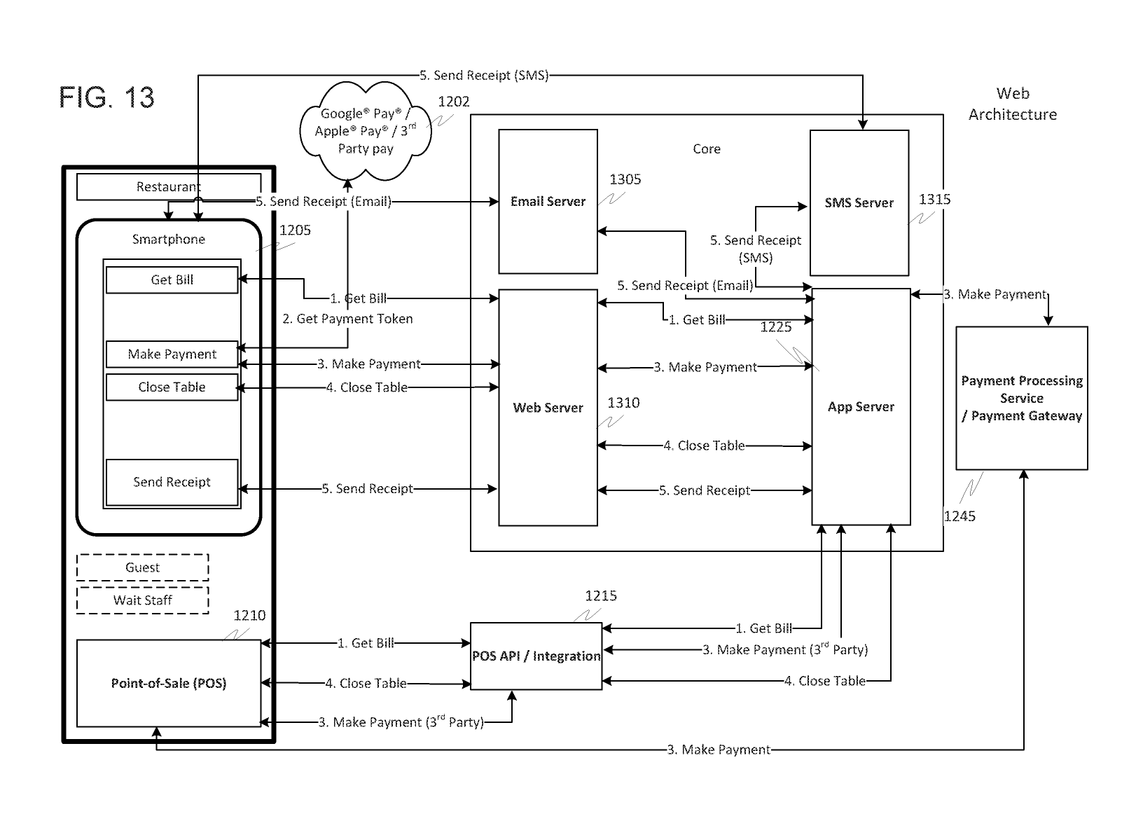

FIG. 13 illustrates an exemplary responsive web architecture and associated operational flow in accordance with one embodiment. The architecture in FIG. 13 is similar to FIG. 12 and contains many of the same components which have been labeled in a similar manner. In addition, the web architecture includes an email server 1305, a web server 1310 and a SMS server 1315.

In step 1, when the user scans the QR code on the table tent, card or the bill, three parameters can be passed as a request to a specified web address:
Merchant ID
Store ID
Table #

This information is received by the web server 1310 which directs the information to the app server 1225 for processing. The request is then directed to the POS API/Integration service 1215 for that particular (restaurant) location ID. The POS 1210 is contacted by the POS API/Integration service 1215 and the order information for that table is collected. The order information is then returned to the device 1205 for display to the guest.

In step 2, when, as one illustrative example, the guest taps on the Google® Pay® (Android®) or Apple® Pay® (iPhone®) button (or comparable button), the action triggers a payment data request. A token is sent in the response by Google®, Apple® or the 3^{rd} party payment provider with this token then used in the next make payment call.

In step 3, and once the token has been returned by Google®, Apple® or the 3^{rd} party payment provider, the token is then sent to the app server 1225 in the core as a payment request. This payment request is then subsequently directed from the web server 1310 to the app server 1225 and then sent to the payment processor 1245 for capture and settlement with the merchant. Once the payment has been successfully processed, the payment information is sent to the POS API/Integration service 1215 and directed to the POS 1210. The payment can then be logged in the POS 1210 as a 3rd Party Payment as discussed. A response is then sent back to the mobile device 1205 for the next step in the process. As with other embodiments, the merchant can then see all payments made through their POS 1210 interface, and the paid amount will then be seen as a settlement amount into the payment processor merchant account.

In step 4, once the response has been received that the payment has been successfully processed, the table can then be closed. The request to close is sent to the POS 1210 via the API/Integration service 1215. The success response and receipt can then be sent back to the device 1205 in step 5.

One exemplary advantage to Pay@Table is that it is the fastest way to pay at restaurants, allowing guests to view and pay for their bill whenever is convenient for them. Pay@Table, as discussed, can be available through a mobile app or without downloading an app such as via a browser interface. Guests can simply use their mobile phones to scan a QR code on their table or bill to quickly be able to view their bill, pay, and close their bill. Payments are processed in seconds and allow guests to use their already set up electronic payment accounts, or quickly scan their credit card to make a payment. Payments are passed directly to the restaurant's point of sale and the table closed, so no extra input is required from wait staff. Additionally, Pay@Table is POS agnostic and can also work with any electronic payment service, any credit card provider, and at any merchant.

An optional embodiment allows the splitting of a bill. For those guest dining with a group, Pay@Table allows the group to split items/portions depending on how they want and pay when they want. Each guest can scan the table QR to be added to a bill. Alternatively, each user can scan the QR code on the bill. This would allow the guest to one or more of: enter a fixed amount to contribute to the bill, allow the guest to select which items to pay for on the bill, allow the guests to split order items between one or more quests, allow each guest to select the item(s) they had, allow each guest to add individual tips and the system can apportion the standard fees such as taxes etc., between the paying quests. This technical solution allows an increase in convenience in that guests can leave when they want and the quests do not have to wait for the table to finish.

Another optional embodiment provides waitlist functionality. As one example, for a guest wanting to place their name on a waitlist at a restaurant, Pay@Table allows the guest to place the name of a dining party on a waitlist for a specific time at a restaurant. Once the dining party arrives at the restaurant for their dining reservation, a table can be automatically allocated to them and the table and restaurant identifier associated with the Pay@Table app. A welcome message and dining table number can optionally be sent to the diners when they are within, for example, a defined geofence of the restaurant. The host at the restaurant can also optionally be notified upon the dining party arriving within the geofence and notified as to which table to escort the guest to. As with the described embodiment, guests can then place their order with the wait staff and can then review their bill and settle using Pay@Table.

Another optional embodiment allows ordering directly from the Pay@Table app. For example, the menu can be pushed to the app and orders placed electronically with the ordered information being communicable to the POS in a similar manner to the payment information described herein.

Another optional embodiment allows reservations. For guests wanting to reserve a table, Pay@Table allows the guest to see all available tables at a specific time, reserve a table, and alert the guests when the table has become available. The host at the restaurant can also be notified the dining party is arriving and which table to escort them to the reserved table. The guests can then place their order with the wait staff and review their bill and settle using Pay@Table.

Another optional embodiment allows customer satisfaction data to be collected. For example, and after the guests have finished, the customer can enter their customer satisfaction feedback on their dining experience including one or more of: scoring of the dining experience such as satisfied/not satisfied/very satisfied, enter additional comments about their experience, or in general respond to any of the standard customer satisfaction questions. Guests in a similar manner could also write a review.

Another optional embodiment allows loyally and rewards. Each time a guest uses Pay@Table they can benefit in one or more of the following ways: gather loyalty points based on number of visits or money spent, receive rewards after so many loyalty points have been awarded, redeem Rewards by receiving an SMS or email reward code to get a discount or free menu item, or the like.

Another optional embodiment allows a bar tab to be created and maintained. For example, Pay@Table allows a user to open a bar tab using their mobile phone. Pay@Table then allows the user to open a bar tab for an individual or group, view the items on a bar tab, add a tip, pay and close their bar tab using their mobile phone. Additionally, each member of the group can pay for their own drinks as described above in relation to splitting a tab, each member can add a separate tip and each member can settle their bill and leave at any time.

Another optional embodiment allows valet service. Pay@Table allows a user to pay for their valet using their mobile phone in a similar manner to paying for a meal. The app can notify the host to deliver their car, notify the guest when their car is ready and pay the valet in the same manner as the restaurant bill.

Exemplary aspects are directed toward:
A system of payment for a transaction comprising:
   an app server that receives an identifier associated with a bill, the identifier scanned or received wirelessly at a merchant location;
   the app server further receiving an electronic payment token corresponding to a payment service usable to pay the bill, the payment token having been selected by a guest;
   a make payment request received by the app server, the make payment request triggering the app server to send an instruction to a payment processing service to pay for the bill;
   the app server further instructing a point-of-sale device to close a ticket associated with the bill when payment has been confirmed.
Any one or more of the above aspects, further comprising a mobile device app, the mobile device app causing a camera on the mobile device to scan a scannable code at the merchant location.
Any one or more of the above aspects, wherein the scannable code is at a table or on a bill at the merchant location.
Any one or more of the above aspects, further comprising an offer server adapted to determine whether any offers are available based at least on the identifier and the bill.
Any one or more of the above aspects, further comprising a loyalty server adapted to apply a loyalty credit to an associated loyalty account of the guest based at least on the bill.
Any one or more of the above aspects, wherein the app server coordinates offers and associated bill adjustments at a point-of-sale via a point-of-sale API service.
Any one or more of the above aspects, further comprising a push provider service adapted to send push notifications from the app server to an app running on a mobile device.
Any one or more of the above aspects, wherein a third party vendor provides the electronic payment token.
A method of payment for a transaction comprising:
   receiving an identifier associated with a bill, the identifier scanned or received wirelessly at a merchant location;
   receiving an electronic payment token corresponding to a payment service usable to pay the bill, the payment token having been selected by a guest;
   receiving a make payment request by the app server, the make payment request triggering the app server to send an instruction to a payment processing service to pay for the bill;
   instructing a point-of-sale device to close a ticket associated with the bill when payment has been confirmed.
Any one or more of the above aspects, further comprising causing a camera on a mobile device to scan a scannable code at the merchant location.
Any one or more of the above aspects, wherein the scannable code is at a table or on a bill at the merchant location.
Any one or more of the above aspects, further comprising determining whether any offers are available based at least on the identifier and the bill.
Any one or more of the above aspects, further comprising applying a loyalty credit to an associated loyalty account of the guest based at least on the bill.
Any one or more of the above aspects, further comprising coordinating offers and associated bill adjustments at a point-of-sale via a point-of-sale API service.
Any one or more of the above aspects, further comprising sending push notifications from the app server to an app running on a mobile device.
Any one or more of the above aspects, wherein a third party vendor provides the electronic payment token.
A computer readable information storage media having stored thereon instructions, that when executed by one or more processors, cause the execution of a method of payment for a transaction comprising:
   receiving an identifier associated with a bill, the identifier scanned or received wirelessly at a merchant location;
   receiving an electronic payment token corresponding to a payment service usable to pay the bill, the payment token having been selected by a guest;
   receiving a make payment request by the app server, the make payment request triggering the app server to send an instruction to a payment processing service to pay for the bill;
   instructing a point-of-sale device to close a ticket associated with the bill when payment has been confirmed.
Any one or more of the above aspects, further comprising causing a camera on a mobile device to scan a scannable code at the merchant location.
Any one or more of the above aspects, wherein the scannable code is at a table or on a bill at the merchant location.
A method of payment for a transaction comprising:
   means for receiving an identifier associated with a bill, the identifier scanned or received wirelessly at a merchant location;
   means for receiving an electronic payment token corresponding to a payment service usable to pay the bill, the payment token having been selected by a guest;
   means for receiving a make payment request by the app server, the make payment request triggering the app server to send an instruction to a payment processing service to pay for the bill;
   means for instructing a point-of-sale device to close a ticket associated with the bill when payment has been confirmed.
Any one or more of the above aspects, further comprising means for causing a camera on a mobile device to scan a scannable code at the merchant location.
Any one or more of the above aspects, wherein the scannable code is at a table or on a bill at the merchant location.
Any one or more of the above aspects, further comprising means for determining whether any offers are available based at least on the identifier and the bill.
Any one or more of the above aspects, further comprising means for applying a loyalty credit to an associated loyalty account of the guest based at least on the bill.
Any one or more of the above aspects, further comprising means for coordinating offers and associated bill adjustments at a point-of-sale via a point-of-sale API service.
Any one or more of the above aspects, further comprising means for sending push notifications from the app server to an app running on a mobile device.
Any one or more of the above aspects, wherein a third party vendor provides the electronic payment token.
A system of payment for a transaction comprising:
   a merchant Point of Sale (POS) configured to receive a unique identifier from a mobile device, the unique identifier scanned from a scannable code or wirelessly received at a diner's table;
   a processing engine configured to receive (a) electronic transaction data including a transaction price and (b) the unique identifier from the merchant POS; and
   a memory storing a database in communication with the processing engine, wherein the database includes a plurality of unique identifiers, wherein each unique identifier is associated with a cash purse and a plurality of non-cash purses including at least one product code purse, wherein the cash purse and each non-cash purse have an associated value, the cash purse value being measured in a currency value and the product code purse value being measured in a quantity of a product of an associated product code,
   wherein, the processing engine separates the electronic transaction data into one or more product code values corresponding to a purse type, each product code value being associated with a product code and a corresponding subtotal of the transaction price;
   wherein, when the processing engine matches the product code associated with one of the product code purses in the database with one of the product codes associated with one of the product code values of the transaction data, the processing engine debits the quantity of the product of the matched product code from the product code purse and reduces the transaction price by the corresponding subtotal of the transaction price of the matched product code, thereby allowing non-standard financial transactions at the merchant POS,
   wherein, after every corresponding subtotal of the transaction price has been debited from the transaction price for matching product codes, the processing engine debits the remaining transaction price from the cash purse value; and
   a processing engine configured to communicate the values associated with the cash purse and product code purse to a mobile and to communicate confirmation of the transaction to the merchant POS system, wherein the processing engine is configured to communicate the values associated with the cash purse and product code purse to a mobile device associated with the unique identifier.

Any one or more of the aspects as substantially described herein.

One or more means adapted to perform any one or more of the above aspects.

Any non-transitory computer readable information storage medium that stores instructions for performing any one or more of the above aspects.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein may show some of the various components of the system collocated, it is to be appreciated that the various components of the system(s) can be located at distant portions of a distributed network, such as a communications network and/or the Internet, or within a dedicated secure, unsecured and/or partially encrypted or fully encryptedsystem. Thus, it should be appreciated that the components of the system can be combined into one or more devices, or collocated on a particular node/element(s) of a distributed network, such as a communications network. As will be appreciated from the description, and for reasons of computational efficiency, the components of the system can be arranged at any location within a distributed network without affecting the operation of the system.

Furthermore, it should be appreciated that the various links, including communications channel(s), connecting the elements (which may not be not shown) can be wired or wireless links, or any combination thereof, or any other known or later developed element(s) that is/are capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts/operational flows have been discussed in relation to a particular exemplary sequence of events, it should be appreciated that changes to this sequence can occur without materially effecting the operation of the embodiment(s). Additionally, the exact sequence of events need not occur as set forth in the exemplary embodiments, but rather the steps can be performed by one or other device(s) in the system. Additionally, the exemplary techniques illustrated herein are not limited to the specifically illustrated embodiments but can also be utilized with the other exemplary embodiments and each described feature is individually and separately claimable, and depending on the embodiment, many aspects are optional.

As will be appreciated by one skilled in the art, aspects of the present disclosure may be embodied as a system, method, and/or computer program product. Thus, aspects of the present disclosure may be embodied entirely in hardware, entirely in software (including, but not limited to, firmware, program code, resident software, microcode), or in a combination of hardware and software. All such embodiments may generally be referred to herein as a circuit, a module, or a system. In addition, aspects of the present invention may be in the form of a computer program product embodied in one or more computer readable media having computer readable program code embodied thereon.

A computer readable medium as described herein may be a computer readable storage medium, examples of which include, but are not limited to, an electronic, magnetic, optical, electromagnetic, infrared, or semiconductor system, apparatus, or device, or any suitable combination thereof. As used herein, a computer readable storage medium may be any non-transitory, tangible medium that can contain or store a program for use by or in connection with an instruction execution system, apparatus, device, computer, computing system, computer system, or any programmable machine or device that inputs, processes, and outputs instructions, commands, or data. A non-exhaustive list of specific examples of a computer readable storage medium include an electrical connection having one or more wires, a portable computer diskette, a floppy disk, a hard disk, a random access memory (RAM), a read-only memory (ROM), a USB flash drive, an non-volatile RAM (NVRAM or NOVRAM), an erasable programmable read-only memory (EPROM or Flash memory), a flash memory card, an electrically erasable programmable read-only memory (EEPROM), an optical fiber, a portable compact disc read-only memory (CD-ROM), a DVD-ROM, an optical storage device, a magnetic storage device, or any suitable combination thereof. A computer readable storage medium can be any computer readable medium that is not a computer readable signal medium such as a propagated data signal with computer readable program code embodied therein.

Program code may be embodied as computer-readable instructions stored on or in a computer readable storage medium as, for example, source code, object code, interpretive code, executable code, or combinations thereof. Any standard or proprietary, programming or interpretive language can be used to produce the computer-executable instructions. Examples of such languages include C, C++, C#, Pascal, JAVA, JAVA Script, BASIC, Smalltalk, Visual Basic, and Visual C++.

Transmission of program code embodied on a computer readable medium can occur using any appropriate medium including, but not limited to, wireless, wired, optical fiber cable, radio frequency (RF), or any suitable combination thereof.

The program code may execute entirely on a user's/operator's/administrator's computer, partly on such a computer or device (such as a smartphone, device or web server), as a stand-alone software package, partly on the user's/operator's/administrator's computer and partly on a remote computer, or entirely on a remote computer or server. Any such remote computer may be connected to the user's/operator's/administrator's computer through any type of network, including a local area network (LAN) or a wide area network (WAN), or the connection may be made to an external computer (for example, through the Internet using an Internet Service Provider).

Additionally, the systems, methods and protocols described herein can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein include, but are not limited to, at least one of Qualcomm® Snapdragon® 800 and 801, Qualcomm® Snapdragon® 610 and 615 with 4G LTE Integration and 64-bit computing, Apple® A7, A8, ABX, A9, A9X, or A10 processors with 64-bit architecture, Apple® M7, M8, M9, or M10 motion coprocessors, Samsung® Exynos® series, the Intel® Core™ family of processors, the Intel® Xeon® family of processors, the Intel® Atom™ family of processors, the Intel Itanium® family of processors, Intel® Core® i9, Intel® Core® X-Series, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJS™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer, workstation, server or mobile device platforms. Alternatively, the disclosed system may be implemented partially in hardware using standard logic circuits or a VLSI design. Whether software or hardware is used to implement the systems in accordance with this invention is dependent on the speed and/or efficiency requirements of the system, the particular function, and the particular software or hardware systems or microprocessor or microcomputer systems being utilized. The methods illustrated herein however can be readily implemented in hardware and/or software using any known or later developed systems or structures, devices and/or software by those of ordinary skill in the applicable art from the functional description provided herein and with a general basic knowledge of the computing arts.

Moreover, the disclosed methods may be readily implemented in software executed on programmed general-purpose computer, a special purpose computer, mobile device, smartphone, a microprocessor, or the like. In these instances, the systems and methods of this invention can be implemented as program embedded on personal computer such as JAVA® or CGI script, as a resource residing on a server or graphics workstation, as a routine embedded in a dedicated fingerprint processing system, as a plug-in, or the like. The system can also be implemented by physically incorporating the system and method into a software and/or hardware system, such as the hardware and software systems of a smart phone, web server and/or transaction processing server(s).

It should be noted that various changes and modifications to the embodiments described herein will be apparent to those skilled in the art. Such changes and modifications may be made without departing from the spirit and scope of the present disclosed technology and without diminishing its attendant advantages. For example, various embodiments of the method may be provided based on various combinations of the features and functions from the subject matter provided herein.

1. A system of payment for a transaction comprising:
an app server that receives an identifier associated with a bill, the identifier scanned or received wirelessly at a merchant location;
the app server further receiving an electronic payment token corresponding to a payment service usable to pay the bill, the payment token having been selected by a guest;
a make payment request received by the app server, the make payment request triggering the app server to send an instruction to a payment processing service to pay for the bill;
the app server further instructing a point-of-sale device to close a ticket associated with the bill when payment has been confirmed.

2. The system of claim 1, further comprising a mobile device app, the mobile device app causing a camera on the mobile device to scan a scannable code at the merchant location.

3. The system of claim 2, wherein the scannable code is at a table or on a bill at the merchant location.

4. The system of claim 1, further comprising an offer server adapted to determine whether any offers are available based at least on the identifier and the bill.

5. The system of claim 1, further comprising a loyalty server adapted to apply a loyalty credit to an associated loyalty account of the guest based at least on the bill.

6. The system of claim 1, wherein the app server coordinates offers and associated bill adjustments at a point-of-sale via a point-of-sale API service.

7. The system of claim 1, further comprising a push provider service adapted to send push notifications from the app server to an app running on a mobile device.

8. The system of claim 1, wherein a third party vendor provides the electronic payment token.

9. A method of payment for a transaction comprising:
receiving an identifier associated with a bill, the identifier scanned or received wirelessly at a merchant location;
receiving an electronic payment token corresponding to a payment service usable to pay the bill, the payment token having been selected by a guest;
receiving a make payment request by the app server, the make payment request triggering the app server to send an instruction to a payment processing service to pay for the bill;
instructing a point-of-sale device to close a ticket associated with the bill when payment has been confirmed.

10. The method of claim 9, further comprising causing a camera on a mobile device to scan a scannable code at the merchant location.

11. The method of claim 10, wherein the scannable code is at a table or on a bill at the merchant location.

12. The method of claim 9, further comprising determining whether any offers are available based at least on the identifier and the bill.

13. The method of claim 9, further comprising applying a loyalty credit to an associated loyalty account of the guest based at least on the bill.

14. The method of claim 9, further comprising coordinating offers and associated bill adjustments at a point-of-sale via a point-of-sale API service.

15. The method of claim 9, further comprising sending push notifications from the app server to an app running on a mobile device.

16. The method of claim 9, wherein a third party vendor provides the electronic payment token.

17. A computer readable information storage media having stored thereon instructions, that when executed by one or more processors, cause the execution of a method of payment for a transaction comprising:
receiving an identifier associated with a bill, the identifier scanned or received wirelessly at a merchant location;
receiving an electronic payment token corresponding to a payment service usable to pay the bill, the payment token having been selected by a guest;
receiving a make payment request by the app server, the make payment request triggering the app server to send an instruction to a payment processing service to pay for the bill;
instructing a point-of-sale device to close a ticket associated with the bill when payment has been confirmed.

18. The media of claim 17, further comprising causing a camera on a mobile device to scan a scannable code at the merchant location.

19. The media of claim 18, wherein the scannable code is at a table or on a bill at the merchant location.

20. A system of payment for a transaction comprising:
a merchant Point of Sale (POS) configured to receive a unique identifier from a mobile device, the unique identifier scanned from a scannable code or wirelessly received at a diner's table;
a processing engine configured to receive (a) electronic transaction data including a transaction price and (b) the unique identifier from the merchant POS; and
a memory storing a database in communication with the processing engine, wherein the database includes a plurality of unique identifiers, wherein each unique identifier is associated with a cash purse and a plurality of non-cash purses including at least one product code purse, wherein the cash purse and each non-cash purse have an associated value, the cash purse value being measured in a currency value and the product code purse value being measured in a quantity of a product of an associated product code,
wherein, the processing engine separates the electronic transaction data into one or more product code values corresponding to a purse type, each product code value being associated with a product code and a corresponding subtotal of the transaction price;
wherein, when the processing engine matches the product code associated with one of the product code purses in the database with one of the product codes associated with one of the product code values of the transaction data, the processing engine debits the quantity of the product of the matched product code from the product code purse and reduces the transaction price by the corresponding subtotal of the transaction price of the matched product code, thereby allowing non-standard financial transactions at the merchant POS,
wherein, after every corresponding subtotal of the transaction price has been debited from the transaction price for matching product codes, the processing engine debits the remaining transaction price from the cash purse value; and
a processing engine configured to communicate the values associated with the cash purse and product code purse to a mobile and to communicate confirmation of the transaction to the merchant POS system,
wherein the processing engine is configured to communicate the values associated with the cash purse and product code purse to a mobile device associated with the unique identifier.
